(19) United States
(12) Patent Application Publication
(10) Pub. No.: US 2010/0287530 A1
(43) Pub. Date: Nov. 11, 2010

(54) REQUIREMENTS DEFINITION USING INTERACTIVE PROTOTYPING

(75) Inventors: Bryan Christopher MacLean, Hammonds Plains (CA); Michael Charles Klobe, Cedar Park, TX (US); Kleanthis Economou, Bridgewater (CA); David Francis Gray, Mineville (CA); David Andrew Walker, Warwick, RI (US)

Correspondence Address: Kokka & Backus, PC;Suite 103, 200 Page Mill Road, Palo Alto, CA, 94306, US

(73) Assignee: Borland Software Corporation, Rockville, MD (US)

(21) Appl. No.: 12/723,551

(22) Filed: Mar. 12, 2010

Related U.S. Application Data
(60) Provisional application No. 61/175,715, filed on May 5, 2009.

(51) Int. Cl. G06F 9/44

(52) U.S. Cl. 717/105

(57) ABSTRACT

Techniques for requirements definition using interactive prototyping are described, including receiving an input from a client, wherein the client is installed on a first computer in data communication with an application simulation server implemented on a second computer, the input being manipulated to graphically identify a requirement for an application being generated using the first computer and the second computer, evaluating the input to identify executable program code associated with the requirement, transforming the input into the executable program code, wherein the application is designed by providing input at the first computer and simulated using the executable program code on the second computer, and generating an interactive simulation of the application by running the executable program code in a simulation environment on the second computer and displaying the application on the first computer, including one or more interfaces associated with the application.

### CROSS-REFERENCE TO RELATED APPLICATIONS

This application is a U.S. nonprovisional patent application that claims the benefit of U.S. Provisional Patent Application No. 61/175,715, filed May 5, 2009 with Attorney Docket No. BOR-239P, and entitled “Requirements Definition Using Interactive Prototyping”, which is herein incorporated by reference for all purposes.

### FIELD

The present invention relates generally to computer software, computer program architecture, and software development techniques and applications. More specifically, techniques for requirements definition using interactive prototyping are described.

### BACKGROUND

Conventional software development is traditionally performed using solutions that rely upon the development of functional requirements or specifications (hereafter “requirements”) in order to identify features or functions that should be built or developed into a computer program or application. In some conventional solutions, computer programs are developed “on-the-fly,” often developing requirements for features and functions on an ad hoc basis. In other conventional solutions, software development methodologies such as agile, waterfall, or iterative are used, developing requirements documents that are used by software development teams in software development projects.

Typically, requirements are often identified using input from departments or functions within an organization, such as marketing or sales. In some conventional software development projects, applications (i.e., software, computer programs, instructions, program code, executables, or the like) are constructed by defining requirements through user groups, focus groups, or surveys. Requirements are often developed by surveying users or intended customers for a software application under development. However, users and customers surveyed are often representative of business users or analysts who identify needs that are solved by software applications within an organization. Business users, analysts, users, and customers are typically not technically trained nor experienced in software development, which results in lengthy specification development processes that can add substantial amounts of time to a software development project during requirements gathering, specification writing, and testing phases.

Conventional solutions for requirements definition and use during a software development project are problematic. Time-consuming requirements definition and transformation of the requirements into functions or features planned for a software development project require time and expertise. The use of conventional software development solutions often take substantial amounts of time, particularly for the development, customization, or integration of a software program for a large-scale organization or enterprise to suit a specific need. Further, software development projects that require and use requirements such as marketing requirements documents, or functional requirement specifications typically require highly trained, experienced software development personnel, resulting in substantial increased costs for a software development project.

Thus, what is needed is a solution for defining software development project requirements without the limitations of conventional techniques.

### BRIEF DESCRIPTION OF THE DRAWINGS

Various embodiments or examples (“examples”) are disclosed in the following detailed description and the accompanying drawings:

FIG. 1 illustrates an exemplary system for requirements definition using interactive prototyping;

FIG. 2 illustrates an exemplary application for requirements definition using interactive prototyping;

FIG. 3A illustrates an alternative exemplary application for requirements definition using interactive prototyping;

FIG. 3B illustrates another alternative exemplary application for requirements definition using interactive prototyping;

FIG. 4A illustrates an exemplary interface for requirements definition using interactive prototyping;

FIG. 4B illustrates another exemplary interface for requirements definition using interactive prototyping;

FIG. 4C illustrates yet another exemplary interface for requirements definition using interactive prototyping;

FIG. 5A illustrates an exemplary summary interface for requirements definition using interactive prototyping;

FIG. 5B illustrates another view of an exemplary summary interface for requirements definition using interactive prototyping;

FIG. 5C illustrates yet another view of an exemplary summary interface for requirements definition using interactive prototyping;

FIG. 5D illustrates a further view of an exemplary summary interface for requirements definition using interactive prototyping;

FIG. 5E illustrates yet another view of an exemplary summary interface for requirements definition using interactive prototyping;

FIG. 6 illustrates an exemplary process for requirements definition using interactive prototyping;

FIG. 7 illustrates an alternative exemplary process for requirements definition using interactive prototyping; and

FIG. 8 illustrates an exemplary computer system suitable for requirements definition using interactive prototyping.

### DETAILED DESCRIPTION

Various embodiments or examples may be implemented in numerous ways, including as a system, a process, an apparatus, a user interface, or a series of program instructions on a computer readable medium such as a computer readable storage medium or a computer network where the program instructions are sent over optical, electronic, or wireless communication links. In general, operations of disclosed processes may be performed in an arbitrary order, unless otherwise provided in the claims.

A detailed description of one or more examples is provided below along with accompanying figures. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For clarity, technical material that is known in the technical fields related to the examples has not been described in detail to avoid unnecessarily obscuring the description.

In some examples, the described techniques may be implemented as a computer program or application (“application”) or as a plug-in, module, or sub-component of another application. The described techniques may be implemented as software, hardware, firmware, circuitry, or a combination thereof If implemented as software, the described techniques may be implemented using various types of programming, development, scripting, or formatting languages, frameworks, syntax, applications, protocols, objects, or techniques, including ASP, ASP.net, .Net framework, Ruby, Ruby on Rails, C, Objective C, C++, C#, Adobe® Integrated Runtime™ (Adobe® AIR™), ActionScript™, Flex™, Lingo™, Java™, Javascript™, Ajax, Perl, COBOL, Fortran, ADA, XML, MXML, HTML, DHTML, XHTML, HTTP, XMPP, PHP, and others. Design, publishing, and other types of applications such as Dreamweaver®, Shockwave®, Flash®, Drupal and Fireworks® may also be used to implement the described techniques. The described techniques may be varied and are not limited to the examples or descriptions provided.

As described herein, computer software, programs, or applications (hereafter “applications”) may be developed with less time and expense, providing unskilled or inexperienced persons with the ability to identify and define functions, features, or other requirements (hereafter “requirements”) for an application using a web, distributed, downloadable, or standalone application to convert requirements into executable program code, thus reducing development time and costs. In some examples, the use of a client that is configured to handle (i.e., render, display, receive, or otherwise process) Flash®, HTML, XML, or other types of data formats in order to transmit data data to an application simulation server that may be implemented locally or on a remote computer (e.g., a server that is part of a data network (e.g., Internet, Local Area Network (LAN), Wide Area Network (WAN), Municipal Area Network (MAN), and others). As used herein, Flash® refers to an application developed by Adobe Systems, Incorporated of San Jose, Calif. Graphical indications and items (hereafter “items”) may be selected using a visual palette or window to define requirements for an application by using click-and-drag, drag-and-drop, or other user interfaces and interactive interface techniques to identify items desired for a given application. Once identified, items may be converted, translated, or otherwise transformed into executable program code (i.e., software program code that may be run on any computer using any type of operating system or environment, including Windows® as developed by Microsoft Corporation of Redmond, Wash., real-time operating systems (RTOS), or open source operating systems, without limitation) that may be used to construct, assemble, build, or otherwise develop (hereafter “develop) a software development project. Using local, test, or actual data, an application may be simulated or prototyped (hereafter “simulated” or “simulating”) by generating an application simulating from an application simulation server using executable program code, providing rapid requirements definition and development. While requirements definition may be performed on a client, an application simulation may be generated remotely and displayed on the client (i.e., on a monitor or display used with a computer instantiating the client). An application simulation, in some examples, may be an application constructed, assembled, developed, designed, implemented, created, or otherwise generated (hereafter “generated”) in order to develop an interactive prototype of an application that users may interact with during the requirements definition and coding processes of software development. Using the described techniques, rapid interactive prototyping may enable users to quickly identify requirements by selecting graphical icons that are representative of section or portions of computer program code (i.e., executable program code). As an example, when a user has completed graphically identifying (i.e., selecting graphical icons) executable program code, a remote server instance of an application simulation server may be used to generate a simulation of a computer program that is interactive when run. As described herein, an application simulation server may be implemented as hardware, software, circuitry, or a combination thereof and configured to perform the described techniques for application development and requirements definition using interactive prototyping. In other examples, the described techniques may be implemented differently and are not limited to the descriptions provided.

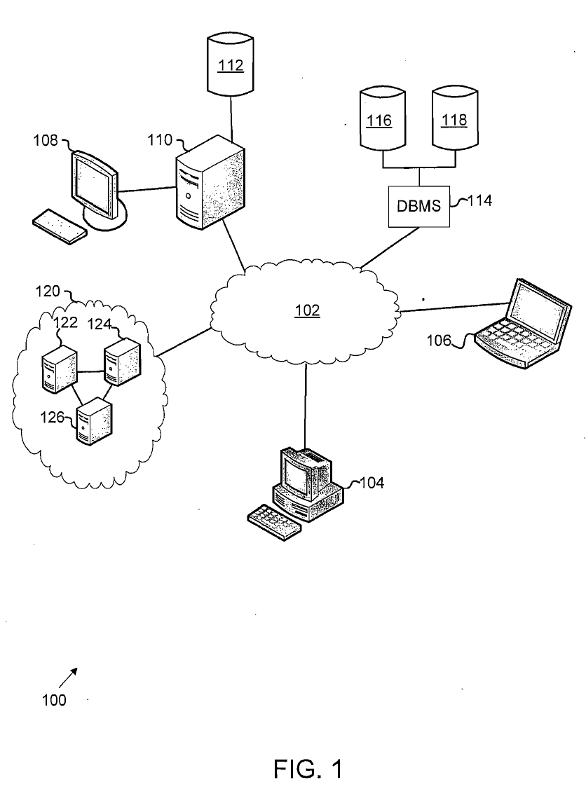

FIG. 1 illustrates an exemplary system for requirements definition using interactive prototyping. Here, system 100 includes network 102, clients 104-106, display 108, server 110, repository 112, database management system (DBMS) 114, repositories 116-118, storage area network 120, and repositories 122-126. The number, type, configuration, function, and implementation of system 100 and elements 102-126 may be varied and the examples shown and described are for purposes of illustration only. In some examples, network 102 may be any type of data network, computing cloud, private or public, using any type of data transmission and/or control protocol (e.g., HTTP, TCP/IP, web, or others). For example, network 102 may be a private LAN, the Internet, or a computing cloud established for purposes of enabling data communication between the elements shown. Clients 104-106 may be any type of computing device, including a desktop computer (e.g., client 104), notebook or laptop computer (e.g., client 106), or another type of computing device (e.g., smart phone, portable computer, personal data assistant, netbook, or others without limitation). Display 108 may be implemented using any type of monitor or other physical device for presenting visual and graphical information and data. Server 110 may be implemented using software, hardware, circuitry, or any combination thereof to provide a computing environment for installing, running, or instantiating any of the described techniques. Repositories 112, 116-118, and 122-126 may be implemented as any type of database, data mart, data warehouse, storage area network, redundant array of independent disks (RAID), storage facility, or any other type of software, hardware, or combination thereof configured to store data or information. In some examples, DBMS 114 may be used to manage one or more database (e.g., repositories 116-118) for storage, retrieval, calls, or other functions associated. In other examples, data may be stored in storage area network 120, which may employ a network of repositories (e.g., repositories 122-126). In still other examples, the number of servers and repositories may be varied and implemented as local, remote, or distributed instances. In yet other examples, system 100 and the above-described elements may be varied in design, function, configuration, implementation, instantiation, or other aspects and are not limited to the examples shown and described.

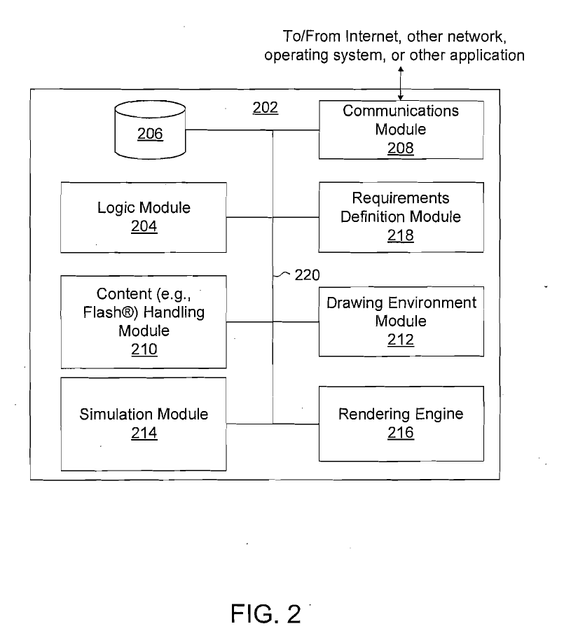

FIG. 2 illustrates an exemplary application for requirements definition using interactive prototyping. Here, application 202 includes logic module 204, repository 206, communications module 208, content handling module 210, drawing environment module 212, simulation module 214, rendering engine 216, and bus 220. In some examples, application 202 illustrates a block modular architecture of an application configured to perform the described techniques. For example, logic module 204 may be implemented as logic configured to generate control signals to repository 206, communications module 208, content handling module 210, drawing environment module 212, simulation module 214, rendering engine 216, and bus 220. Logic module 204 may be implemented as a module, function, subroutine, function set, rule set, or other type of software, hardware, circuitry, or combination that enables control of application 202 and the described elements.

In some examples, communications module 208 may be configured to send and receive data from application 202. For example, application 202 may be implemented on one or more remote servers and, when a message (e.g., data packet) is received from a remote client over a data network (e.g., network 102 (FIG. 1)), communications module 208 receives, decodes, or otherwise interprets data from the message and transmits the data over bus 220 to content handling module 210, requirements definition module 218, and simulation module 214. Once interpreted (i.e., decoded, or otherwise processed for use by application 202), data is used to identify whether a specific graphical input has been received to indicate whether a given feature or function is to be included in an application that is being developed.

In other examples, drawing environment module 212 is configured to generate and present a drawing environment on a local or remote client, without limitation, in order to present one or more graphical user interfaces (hereafter “interface” or “interfaces”) for display at a client. As an example, an interface may be generated and presented by rendering engine 216 that allows a user, regardless of training, education, or experience, to select a graphical picture of a feature or function that she wishes to have implemented in a given application. If a table, for example, is selected, drawing environment module 212 receives that input, which is communication using communications module 208 to content handling module 210, which is configured to determine executable program code that is associated with the selected graphical input, item, or indication. In some examples, an input may be a graphical, visual, or iconic representation displayed on a computer screen that, when selected using an input/output device (e.g., mouse, keyboard, or others) indicates an item (e.g., data structure (e.g., table, record, file, queue, or others), function (e.g., pull down menu, pop-up window, or others), feature (e.g., radio button, text box, form, or others)) or type of item that should be included in an application. As shown, content handling module 210 may be used to interpret data and information entered in a drawing environment. Content handling module 210, in some examples, may be configured to interpret data and information entered, created, authored, formatted, modified, or otherwise operated upon using any type of protocol or format. For example, content handling module 210 may be configured to interpret data formatted using hypertext markup language (HTML), extensible markup language (XML), web services distributed language (WSDL), or others. Content handling module 210 may also be implemented to interpret data formatted or otherwise modified using various types of applications and frameworks, such as Flash®, Flex®, AIR™, Ruby on Rails®, or others that may be used to develop internet application or rich internet applications (RIA). Flash®, Flex®, and AIR™ are developed by Adobe Systems of San Jose, Calif. and Ruby on Rails® is an open source software project released by Yukihiro Matsumoto. In other examples, content handling module 210 may be configured to interpret, handle, read, transform, or otherwise process data formatted in other types of protocols, formats, scripts, or languages, without limitation.

As shown, repository 206 may be implemented as a single, multiple-instance, standalone, distributed, or other type of data storage facility, similar to those described above in connection with FIG. 1. In other examples, repository 206 may also be implemented partially or completely as a local storage facility for data operated upon by application 202 and the described elements. In other examples, repository 206 may be a remote data storage facility that is used to provide storage for application 202. Still further, some or all of repository 206 may be used to provide a cache or queue for one or more of the elements shown for application 202.

In some examples, simulation module 214 may be used to generate application simulations using input provided within a drawing environment presented by drawing environment module 212. As used herein, “application simulation” may refer to the process of receiving a graphical input indicating a requirement for an application within a drawing environment presented on a client and, after receipt and processing of the input, identifying executable program code that is used to construct (i.e., develop) an application, thus reducing the time from identifying a requirement to development of associated executable program code. Application simulations may include other processes, routines, or functions apart from those described, but are generated in order for a user (e.g., business analyst, marketing personnel, salesperson, software developer, or other) to graphically identify a requirement for an application and, using application 202, run the associated executable program code (which may be compiled, uncompiled, in binary or other formats) in a simulation using test, local, remote, or other sources of data without requiring complete development, integration, and testing before runtime. In other words, application 202 and the above-described elements allow applications to be built using graphical inputs provided using an interface in order to design and construct an application and then run as a simulation for purposes of expeditious troubleshooting and testing at substantially reduced expense in both time and labor.

Here, application 202 may be configured to present interfaces having Flash®-formatted or embedded content. Providing input using an interface (not shown) that is configured to handle Flash®, HTML, XML, or other types of formatted or programmed content allows a user to graphically identify a feature or function that she wishes to include as part of an application. For example, by selecting an icon representing a table, a requirement is identified for a table within an application and, when selected, application 202 (i.e., requirements definition module 218 and simulation module 214) generates the associated executable program code and enables simulation of the run-time environment of the application, thus showing the table. When, for example, the table is shown, rendering engine 216 may be used to render the graphical appearance of the table and the resulting, simulated application. In other examples, application 202 and the above-described elements may be varied in design, function, configuration, implementation, instantiation, or other aspects and are not limited to the examples shown and described.

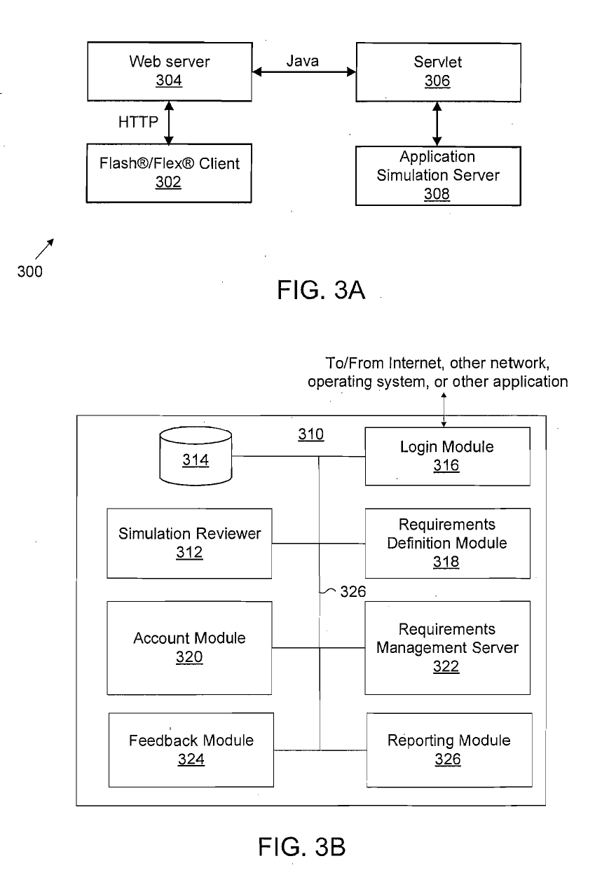

FIG. 3A illustrates an alternative exemplary application for requirements definition using interactive prototyping. Here, application 300 may be implemented to include client 302, web server 304, servlet 306, and application simulation server 308. In some examples, an interface (not shown) may be presented by application simulation server 308 on client 302 by transmitting data to servlet 306 using Java, which is subsequently transmitted by servlet 306 to web server 304. In turn, web server 304 transmits data as generated HTML or XML to render an interface on client 302 using a data transmission protocol such as HTTP. Further, client 302 may be configured to present an interface associated with an application that is not delivered via a web browser (not shown), but by using web server 304, an application simulation interface providing a drawing environment for graphically indicating input for an application may be performed on client 302. In other examples, application 300 and the above-described elements may be varied in design, function, configuration, implementation, instantiation, or other aspects and are not limited to the examples shown and described.

FIG. 3B illustrates another alternative exemplary application for requirements definition using interactive prototyping. Here, application 310 may include simulation reviewer 312, repository 314, login module 316, requirements definition module 318, account module 320, requirements management server 322, feedback module 324, and reporting module 326. In some examples, application 310 may be implemented to enable application simulation using inputs provided from a Flash®-enabled client, as described above in connection with FIG. 2. As an example, a user may log in to a client, which may be detected by login module 316. When detected, login module 316 may be used to transfer data between a client (not shown) and account module 320 to determine what authorization or entitlements a given account may have. Once determined, actions are enabled for the logged-in user, who may use an interface to graphically indicate input for identifying (i.e., defining) requirements for an application. Using an interface presented at a client, data may be entered and transmitted to client 310 indicating, as a graphical selection, an item (i.e., requirement) to be included with an application. When the item is received by login module 316, data associated with the item is passed to requirements definition module 318 to generate executable program code that may be built or incorporated into an application under development. Further, requirements indicated by the graphical selection of items on an interface presented on a client may also be managed using an interface on the client.

In some examples, requirements management server 322 may be implemented and used to manage, control, add, delete, or otherwise modify requirements associated with an application under development. For example, multiple items may be graphically selected using an interface (e.g., selecting a table, interactive icon, button, and controls) presented on the client. An interface configured to manage requirements may be the same or different than an interface presented on a client for identifying or defining requirements. Further, each of requirements definition module 318 and requirements management server 322 may be configured to generate, render, and present for display, interfaces associated with requirement definition and management, respectively. In other examples, requirements definition module 318 and requirements management server 322 may be implemented differently or modified from the descriptions provided, including using data provided at a client to feedback module 324.

Here, feedback module 324 may be implemented to provide feedback from clients (Le., users interacting with application 310 on one or more clients). In some examples, feedback may be graphically or visually presented (i.e., displayed) on a monitor or computer associated with a client. Further, data associated with feedback may be input to application 310 and stored on repository 314, the latter of which may be implemented using one or more storage facilities (e.g., databases, data marts, or other storage mechanisms such as those described above). Still further, data associated with any operation performed by application 310 or any of the described elements (e.g., simulation reviewer 312, repository 314, login module 316, requirements definition module 318, account module 320, requirements management server 322, feedback module 324, and reporting module 326).

In some examples, simulation reviewer 312 may be used to generate an application simulation using data from one or more of repository 314, login module 316, requirements definition module 318, account module 320, requirements management server 322, feedback module 324, and reporting module 326. When input is provided at a client, transformation of the input is performed at the client into data that is transmitted to application 310. Upon receipt at application 310, data is processed and used to identify requirements for an application. In some examples, requirements management server 322 may be configured to cooperatively process inputs from a client to determine whether an instruction has been received from the client to generate and run a simulation. In other examples, simulation reviewer 312 may also provide data regarding application simulations to reporting module 326, which may be configured to generate reports regarding scenarios, simulations, data sources, or any other aspects of an application simulation. Further, other modules beyond those shown and described may be included with application 310. For example, modules, components, or portions of functionality may be implemented with application 310 that provide project management, measurement, metrics reporting, analysis, business intelligence, demand management, or other features or functionality for use in the application lifecycle management (ALM) or other software development industries and sectors. In other examples, application 310 and the above-described elements may be varied in design, function, configuration, implementation, instantiation, or other aspects and are not limited to the examples shown and described.

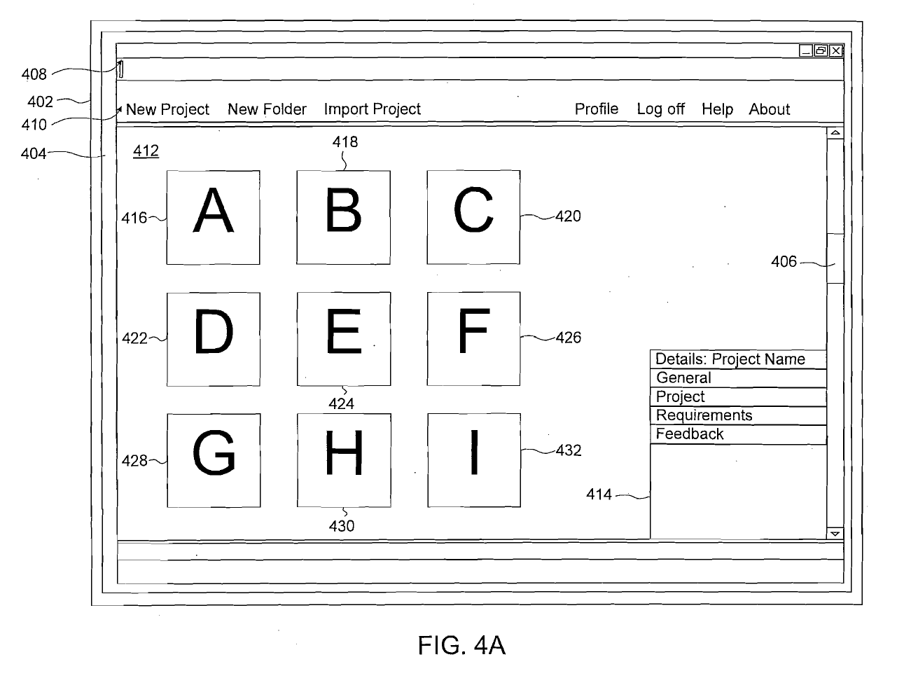

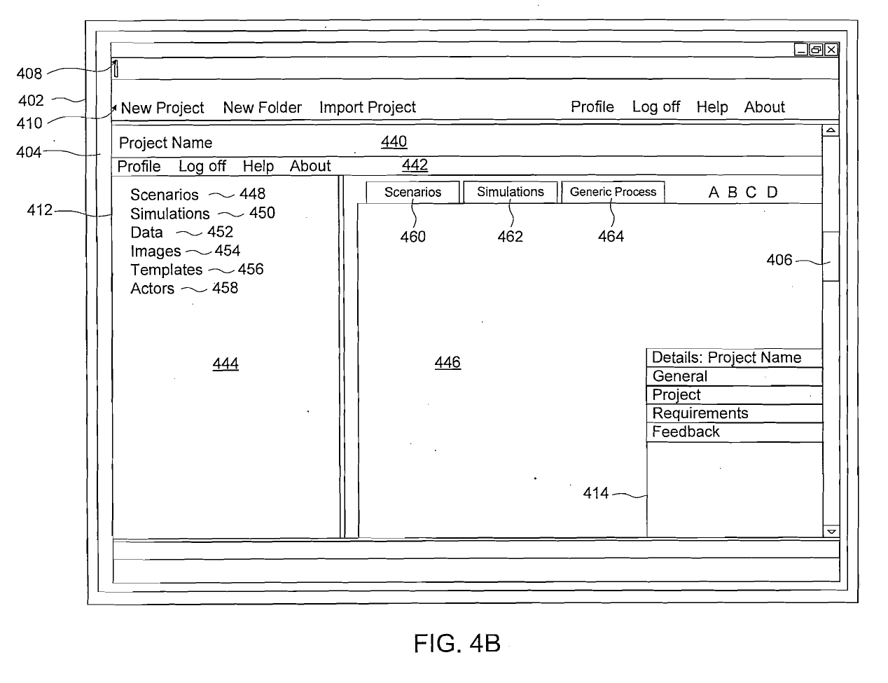

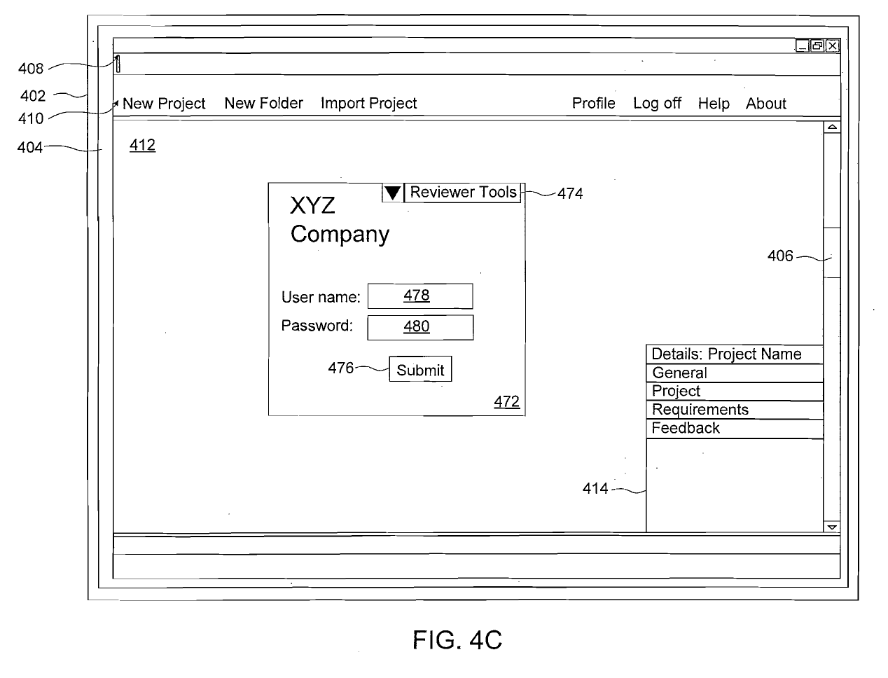

FIG. 4A illustrates an exemplary interface for requirements definition using interactive prototyping. Here, interface 402 includes window 404, scroll bar 406, regions 408-410, windows 412-414, and icons 416-432. In some examples, interface 402 may be an exemplary interface presented on a client that is configured to receive the entry of graphical input (i.e., selection of an item based on manipulation or selection of the item using an input/output device (e.g., pointer manipulated by a keyboard or mouse)) for identifying a requirement of an application under development. For example, options may be presented in region 410 that may be selected to invoke functions to create a new project (“New Project”), open a folder into which materials (“New Folder”) may be deposited, import a file associated with a new project (“Import Project”), view an account profile (“Profile”), log off of the client application (“Log off”), retrieve helpful information (“Help”), or request information regarding the client application (“About”), or others.

In some examples, each of icons 416-432 may represent an application project being developed. Alternatively, one or more of icons 416-432 may also be representative of different types of projects, files, records, or data that may be configured for interaction in interface 402. Examples of interaction may include selecting, saving, opening, closing, deleting, or modifying the icon by using an input/output device to select one of icons 416-432. Further, when selected, data may be retrieved from a remote or networked server (e.g., server 110 (FIG. 1)). For example, if icon 418 is selected, interface 402 may be configured to present options associated with the application project (i.e., application being developed) represented by icon 418. Still further, when one of icons 416-432 is selected, representative information associated with the selected project may be presented in window 414 (e.g., project name, general information, project information, requirements associated with each project, feedback information, and the like). In other examples, interface 402 and the above-described elements may be varied in design, function, configuration, implementation, instantiation, or other aspects and are not limited to the examples shown and described.

FIG. 4B illustrates another exemplary interface for requirements definition using interactive prototyping. Here, interface 402 includes window 404, scroll bar 406, regions 408-410, windows 412-414, regions 440-446, items 448-458, and tabbed windows 460-464. In some examples, interface 402, window 404, scroll bar 406, regions 408-410, and windows 412-414 may be implemented similarly or substantially similar to the similar numbered elements described above in connection with FIG. 4A. As shown here, interface 402 may be modified when an application is selected (i.e., one of icons 416-432 (FIG. 4A) is selected) to present regions 440-446. Region 440 may be used to present information associated with the selected project (e.g., project name). Region 442 may be configured to provide options (e.g., pull down menus) such as reviewing information regarding the profile for the given project (“Profile”), logging off of the selected project (“Log off”), obtaining helpful information associated with the project (“Help”), or reviewing information about the client when a project is selected (“About”). Other options may also be presented in either of regions 440-442.

When a project is selected, in some examples, a list of options may be presented in region 444, including “Scenarios,” “Simulations,” “Data,” “Images,” “Templates,” “Actors,” and others. Each of the listed options presented (i.e., displayed) in region 444 may have other features or functions that are invoked when selected. Further, when one of the listed options in region 444 is selected using an input/output mechanism, a graphical input is performed, assigning a scenario, simulation, data, image, template, actor, or other requirement to the application under development. Further, by selecting one of tabbed windows 460-464, additional information may be presented in region 446. In other examples, interface 402 and the above-described elements may be varied in design, function, configuration, implementation, instantiation, or other aspects and are not limited to the examples shown and described.

FIG. 4C illustrates yet another exemplary interface for requirements definition using interactive prototyping. Here, interface 402 includes window 404, scroll bar 406, regions 408-410, windows 412-414, window 472, reviewer tools 474, and features 476-480. As an example, when a simulation is run of an application, a “pop-up” window may be presented (e.g., window 472). As an example, features 476-480 represent a submit button, username input field, and password input field that were selected using, for example, interface 402 as shown in FIG. 4B. When an application simulation is run using the requirements previously identified (e.g., features 476-480), window 472 is generated to appear as though the application and its underlying executable program code are being run. However, in some examples, dummy, fictitious, or non-critical data may be used to populate window 472 and features 476-480 in order to avoid the need to stage or deploy an application prior to testing. For example, an application simulation run in a simulation environment does not require the use of actual data when the application under development is deployed (i.e., launched, released, or the like). In other words, when an application simulation is generated and run, a simulation environment is created. In some examples, a “simulation environment” may refer to any computing environment that is used to run an application simulation. For example, a simulation environment may refer to an operating environment that is configured to use test data, as opposed to actual data, for use with an application simulation in order to test an application under development without affecting valuable business or organizational data. When an application simulation is performed, window 472 displays features or functions that were identified as requirements. Likewise, window 414 may be presented with information associated with application being simulated and run in window 472. In other examples, interface 402 and the above-described elements may be varied in design, function, configuration, implementation, instantiation, or other aspects and are not limited to the examples shown and described.

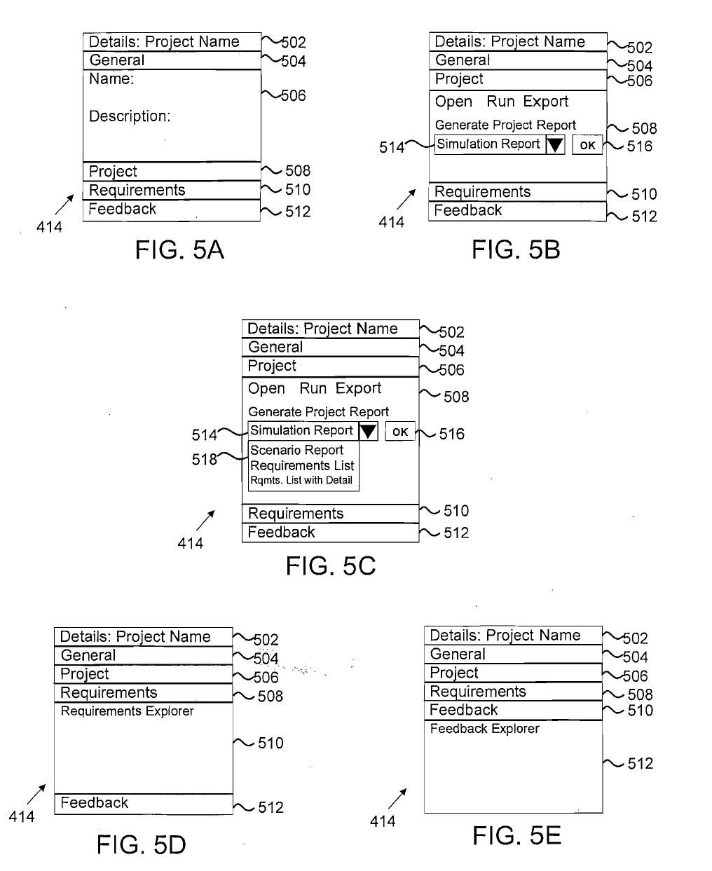

FIG. 5A illustrates an exemplary summary interface for requirements definition using interactive prototyping. Here, window 414 is shown with expanding windows 502-512. In some examples, window 414 may be implemented similarly or substantially similar to window 414 shown in FIGS. 4A-4C. As shown, any of expanding windows 502-512 may be selected by using an input/output device that, when interacting with any of expanding windows 502-512, results in the expansion of the selected window, exposing space in which additional information, features, or functions may be presented.

In some examples, expanding window 502 may be configured to present information associated with details of a given project, such as the project name for a given software development project (i.e., application under development). Expanding window 504 may be configured to present general information associated with a given application project. Here, expanding window 504 illustrates additional fields for entering general information associated with a given project, including a project name and description. In other examples, expanding window 504 may be configured to present information beyond that described here.

FIG. 5B illustrates another view of an exemplary summary interface for requirements definition using interactive prototyping. Here, window 414 is shown with expanding windows 502-512, pull down menu 514, and submit button 516. In some examples, window 414 may be implemented similarly or substantially similar to window 414 shown in FIGS. 4A-4C. In some examples, when expanding window 506 is selected, additional options to open a project (“Open”), run a project (“Run”), export a project (“Export”), generating reports (“Generate Project Report”), or others may be presented. For example, pull down menu 514 and submit button 516 are presented in expanding window 508. When pull down menu 514 is selected, as an example, one or more options may be presented, as described below in greater detail in connection with FIG. 5C.

FIG. 5C illustrates yet another view of an exemplary summary interface for requirements definition using interactive prototyping. Here, window 414 is shown with expanding windows 502-512, pull down menu 514, and submit button 516. In some examples, window 414 may be implemented similarly or substantially similar to window 414 shown in FIGS. 4A-4C. When pull down menu 514 is selected, one or more options (e.g., “Scenario Report,” “Requirements List,” Requirements List with Detail,” or others) may be presented in expanding window 508. Further, when one of the options presented in pull down menu 514 is selected and submit button 516 is “depressed” (i.e., selected or invoked using an input/output device), an option is performed.

In some examples, when an option is performed, user input is converted into an item (i.e., one or more data packets) that is sent from a client to application 202 (FIG. 2) or another application implementing application simulation, as described herein. For example, when an input is sent from a client to application (310) indicating a scenario report is to be generated, data may be retrieved from repository 314 and, using reporting module 326 and simulation reviewer 312, a scenario report may be generated, rendered, and presented in interface 402 (FIGS. 4A-4C). In other examples, different types of options may result in the generation or production of different types of reports or other data being presented within interface 402, window 414 (FIGS. 4A-4C), window 472 (FIG. 4C), or other portions, frames, windows, or palettes associated with a client or a client application used to generate requirements definition using interactive simulations (i.e., “application simulations”). In other examples, techniques other than pull down menus may be used to present additional information, options, features, or functions other than the example shown with pull down menu 514.

FIG. 5D illustrates a further view of an exemplary summary interface for requirements definition using interactive prototyping. Here, window 414 is shown with expanding windows 502-512. When window 510 is selected, expansion occurs revealing a requirements explorer function that enables a user to review information associated with requirements for the given project being evaluated. In some examples, “explorer” may refer to a set of functions that enable a user to review, search, order, or perform other operations with regard to information that appears in a window (e.g., expanding windows 502-512). In other words, requirements associated with the selected project (as identified by the project name indicated in expanding window 502) may be listed in expanding window 510. In other examples, different types of information may be presented in expanding window 510 and may be rendered, designed, or implemented with different features, functionality, layouts, or other varied aspects apart from those shown and described.

FIG. 5E illustrates yet another view of an exemplary summary interface for requirements definition using interactive prototyping. Here, window 414 is shown with expanding windows 502-512. In some examples, when expanding window 512 is selected, feedback provided in the present application (again, as identified by the project name listed in expanding window 502) may be presented in the expanded space. Likewise, more, less, or different information apart from feedback may be presented in expanding window 512. In other examples, window 414 and expanding windows 502-512 as described above in connection with FIGS. 5A-5E may be varied in design, function, configuration, implementation, instantiation, or other aspects and are not limited to the examples shown and described.

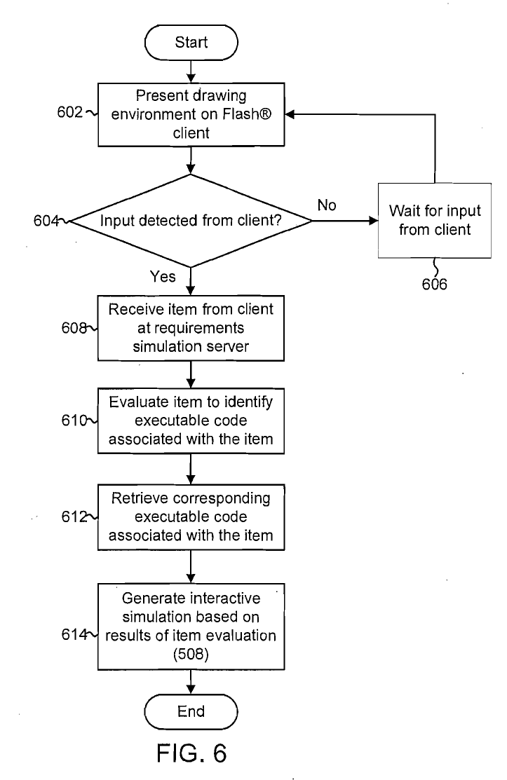

FIG. 6 illustrates an exemplary process for requirements definition using interactive prototyping. Here, a drawing environment configured to receive input from, for example, a user (e.g., business analyst, project manager, or other) is presented on a client (602). A determination is made as to whether an input is detected from the client (604). If no input is detected, then the process loops to wait for an input from a client configured to received input (606). In some examples, a client may be configured to be an application installed on a client computer and implemented to handle (i.e., process) various types of content, including Flash®, HTML, XML, or other data formatted or authored using various languages, formats, or protocols such as those described herein.

In other examples, if an input is detected from a client (604), the input is translated into an item (e.g., a message, signal, data, dataset, packet, group of data packets, or the like) that is received by a requirements simulation server (e.g., application 202 (FIG. 2), application 310 (FIG. 3B), or others) (608). Once received, the item is evaluated to identify executable program code associated with the given item (610). For example, if a user indicates, using client 302 (FIG. 3A), for example, that a text entry field and submission button are requirements for an application, the input is converted into an item that is transmitted from a client to a requirements definition server (e.g., requirements definition module 218 (FIG. 2), requirements defmition module 318 (FIG. 3), or the like), which identifies and retrieves executable program code that corresponds to the item and is used to construct the application (612). When corresponding executable program code is retrieved and used to construct an application based on input provided by a client (or multiple clients), an interactive simulation (i.e., application simulation) may be generated to enable users to interact with the application under development (614). In other examples, the above-described process may be varied in design, processes, order, or other aspects and is not limited to the descriptions provided.

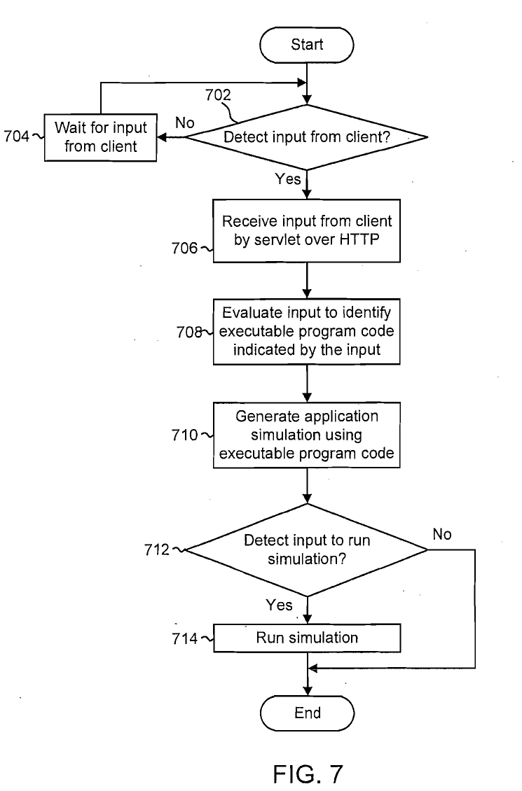

FIG. 7 illustrates an alternative exemplary process for requirements definition using interactive prototyping. Here, a determination is made as to whether an input is detected at a client (702). In some examples, an input may be detected by a remote computer (e.g., server 110 (FIG. 1)), servlet, web server, or other software, hardware, circuitry, or combination thereof, without limitation. If no input is detected, then the process waits (e.g., loops) for the detection of an input at a client (e.g., clients 104-106 (FIG. 1)) (704). Alternatively, if an input is detected, then the input is received from the client by a servlet configured to transmit (i.e., send and receive) data over hypertext transfer protocol (HTTP) or another data transmission protocol (706). Once received, the input is used to identify executable program code (708). In some examples, evaluating an input to identify executable program code may be performed by determining if the input indicates a requirement for an application. As an example, a requirement may be an item to be included in an interface that is presented when an application is run. Examples of items may include data or text entry fields, controls, features, or functions associated with a given application.

Here, after identifying executable program code corresponding to the input from the client, an application simulation may be generated (710). In some examples, an application simulation may be a compilation or aggregation of executable program code that a user has entered as input for requirements for an application under development. After generating an application simulation, a determination is made as to whether a further input is provided to run the application simulation (712). If further input indicating running or executing an application simulation is detected, then the process ends. In other examples, the above-described process may be implemented to await another input indicating whether to run the application simulation. In still other examples, the above-described process may also be implemented to await another input indicating a further requirement for the application (and application simulation). Alternatively, if an input indicating running an application simulation is detected, then the simulation is run (714). Subsequently, the above-described process ends. In further examples, the above-described process may be varied in design, processes, order, or other aspects and is not limited to the descriptions provided.

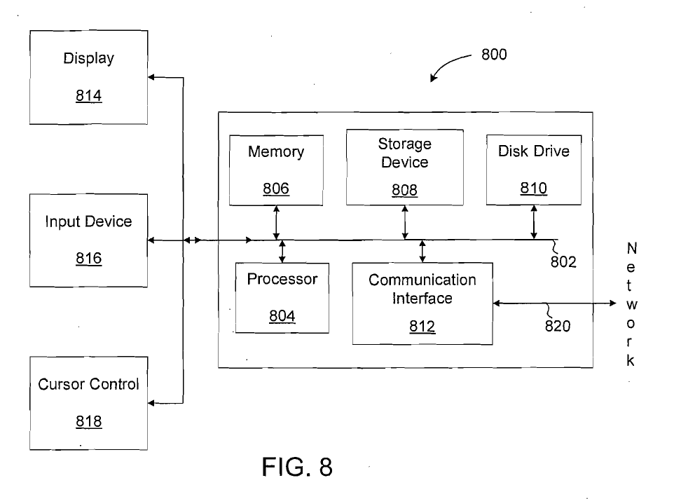

FIG. 8 illustrates an exemplary computer system suitable for requirements definition using interactive prototyping. In some examples, computer system 800 may be used to implement computer programs, applications, methods, processes, or other software to perform the above-described techniques. Computer system 800 includes a bus 802 or other communication mechanism for communicating information, which interconnects subsystems and devices, such as processor 804, system memory 806 (e.g., RAM), storage device 808 (e.g., ROM), disk drive 810 (e.g., magnetic or optical), communication interface 812 (e.g., modem or Ethernet card), display 814 (e.g., CRT or LCD), input device 816 (e.g., keyboard), and cursor control 818 (e.g., mouse or trackball).

According to some examples, computer system 800 performs specific operations by processor 804 executing one or more sequences of one or more instructions stored in system memory 806. Such instructions may be read into system memory 806 from another computer readable medium, such as static storage device 808 or disk drive 810. In some examples, hard-wired circuitry may be used in place of or in combination with software instructions for implementation.

The term “computer readable medium” refers to any tangible medium that participates in providing instructions to processor 804 for execution. Such a medium may take many forms, including but not limited to, non-volatile media and volatile media. Non-volatile media includes, for example, optical or magnetic disks, such as disk drive 810. Volatile media includes dynamic memory, such as system memory 806.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read.

Instructions may further be transmitted or received using a transmission medium. The term “transmission medium” may include any tangible or intangible medium that is capable of storing, encoding or carrying instructions for execution by the machine, and includes digital or analog communications signals or other intangible medium to facilitate communication of such instructions. Transmission media includes coaxial cables, copper wire, and fiber optics, including wires that comprise bus 802 for transmitting a computer data signal.

In some examples, execution of the sequences of instructions may be performed by a single computer system 800. According to some examples, two or more computer systems 800 coupled by communication link 820 (e.g., LAN, PSTN, or wireless network) may perform the sequence of instructions in coordination with one another. Computer system 800 may transmit and receive messages, data, and instructions, including program, i.e., application code, through communication link 820 and communication interface 812. Received program code may be executed by processor 804 as it is received, and/or stored in disk drive 810, or other non-volatile storage for later execution.

Although the foregoing examples have been described in some detail for purposes of clarity of understanding, the above-described inventive techniques are not limited to the details provided. There are many alternative ways of implementing the above-described invention techniques. The disclosed examples are illustrative and not restrictive.

What is claimed:

1. A method, comprising:
presenting a drawing environment on a client configured to process Flash® formatted content, the client being in data communication with a requirements definition server implemented on a remote computer;
receiving an item in the drawing environment, wherein the item comprises an input configured to graphically indicate a requirement for an application;
evaluating the item to identify executable program code to construct the application; and
generating an interactive simulation by running the executable program code in the simulation environment, wherein the interactive simulation is an application comprising logic, data, and one or more interfaces configured to receive user input.

2. The method of claim 1, wherein evaluating the item further comprises identifying a type associated with the item.

3. The method of claim 1, wherein the type is a table.

4. The method of claim 1, wherein the type is a database schema.

5. The method of claim 1, wherein the type is a function or process.

6. The method of claim 1, wherein the requirements definition server is an application server.

7. The method of claim 1, wherein the requirements definition server is in data communication with a requirements management server.

8. The method of claim 1, further comprising running the executable program code in the simulation environment using the requirements definition server, wherein the executable program code is configured to use data stored on a local repository or a remote repository.

9. A method, comprising:
receiving an input from a client, wherein the client is installed on a first computer in data communication with an application simulation server implemented on a second computer, the input being manipulated to graphically identify a requirement for an application being generated using the first computer and the second computer;
evaluating the input to identify executable program code associated with the requirement;
transforming the input into the executable program code, wherein the application is designed by providing input at the first computer and simulated using the executable program code on the second computer; and
generating an interactive simulation of the application by running the executable program code in a simulation environment on the second computer and displaying the application on the first computer, including one or more interfaces associated with the application.

10. The method of claim 9, wherein data used to run the executable program code in the simulation environment is retrieved from the first computer.

11. The method of claim 9, wherein data used to run the executable program code in the simulation environment is retrieved from the second computer.

12. The method of claim 9, wherein the client is a rich internet application.

13. The method of claim 9, wherein the client is configured to receive present Flash®-formatted content.

14. The method of claim 9, wherein one or more interfaces configured to present Flash®-formatted content are presented by the client on the first computer.

15. A system, comprising:
a memory configured to store data associated with an interactive simulation;
a client configured to present Flash®-formatted content; and
an application simulation server in data communication with the client, the application simulation server being configured to present a drawing environment on the client to receive an item in the drawing environment, wherein the item comprises an input configured to graphically indicate a requirement for an application, to evaluate the item to identify to construct the application, and to generate an interactive simulation by running the executable program code in the simulation environment, wherein the interactive simulation is an application comprising logic, data, and one or more interfaces configured to receive user input.

16. The system of claim 15, wherein the client is in data communication with the application simulation server.

17. The system of claim 15, wherein the client is implemented on a first computer and the application simulation server is implemented on a second computer, wherein the first computer and the second computer are in data communication using one or more data networks.

18. The system of claim 15, wherein the client transmits the input to a servlet associated with the application simulation server, the input being formatted using hypertext transfer protocol.

19. A system, comprising:
a database configured to store data associated with an application simulation; and
logic configured to receive an input from a client, wherein the client is installed on a first computer in data communication with an application simulation server implemented on a second computer, the input being manipulated to graphically identify a requirement for an application being generated using the first computer and the second computer, to evaluate the input to identify executable program code associated with the requirement, to transform the input into the executable program code, wherein the application is designed by providing input at the first computer and simulated using the executable program code on the second computer, to generate the interactive simulation of the application by running the executable program code in a simulation environment on the second computer and displaying the application on the first computer, including one or more interfaces associated with the application.

20. A computer program product embodied in a computer readable medium and comprising computer instructions for:
presenting a drawing environment on a client configured to process Flash® formatted content, the client being in data communication with a requirements definition server implemented on a remote computer;
receiving an item in the drawing environment, wherein the item comprises an input configured to graphically indicate a requirement for an application;
evaluating the item to identify an executable analogue, wherein the executable analogue comprises executable program code used to construct the application; and generating an interactive simulation by running the executable program code in the simulation environment, wherein the interactive simulation is an application comprising logic, data, and one or more interfaces configured to receive user input

21. A computer program product embodied in a computer readable medium and comprising computer instructions for:
receiving an input from a client, wherein the client is installed on a first computer in data communication with an application simulation server implemented on a second computer, the input being manipulated to graphically identify a requirement for an application being generated using the first computer and the second computer;
communicating the input from the first computer to the second computer;
evaluating the input to identify executable program code associated with the requirement;
transforming the input into the executable program code, wherein the application is designed by providing input at the first computer and simulated using the executable program code on the second computer; and
generating an interactive simulation of the application by running the executable program code in a simulation environment on the second computer and displaying the application on the first computer, including one or more interfaces associated with the application.
